(19) United States
(12) Patent Application Publication
(10) Pub. No.: US 2013/0334460 A1
(43) Pub. Date: Dec. 19, 2013

(54) TITANO-SILICO-ALUMINO-PHOSPHATE

(71) Applicants: Silke Sauerbeck, Bruckmuhl (DE); Olga Manoylova, Munchen (DE); Arno Tissler, Tegernheim (DE); Martin Dienersberger, Kolbermoor (DE)

(72) Inventors: Silke Sauerbeck, Bruckmuhl (DE); Olga Manoylova, Munchen (DE); Arno Tissler, Tegernheim (DE); Martin Dienersberger, Kolbermoor (DE)

(73) Assignee: Clariant Produkte (Deutschland) GmbH, Frankfurt / Main (DE)

(21) Appl. No.: 13/996,030

(22) PCT Filed: Dec. 21, 2011
(86) PCT No.: PCT/EP11/73686

§ 371 Date: Sep. 5, 2013

(30) Foreign Application Priority Data
Dec. 22, 2010 (DE) 10 2010 055 679.3

(51) Int. Cl. B01J 29/89; B01J 20/18; B01J 20/30

(52) U.S. Cl. CPC B01J 29/89; B01J 20/3078; B01J 20/18
USPC 252/194; 423/700; 502/60; 502/74; 502/61; 502/73

(57) ABSTRACT

A titano-silico-aluminophosphate which contains tetrahedrally coordinated titanium in the framework structure, which has a free coordination site for CO which can be detected by means of a characteristic IR band at 2192±5 cm⁻¹. The titano-silico-aluminophosphate has extremely high hydrothermal stability and has a good adsorption capacity even at higher temperatures. Also, a hydrothermal method to obtain a titano-silico-aluminophosphate starting from a synthetic gel mixture of an aluminium, phosphorus, silicon and a titanium source, as well as corresponding templates.

### CROSS-REFERENCE TO RELATED APPLICATIONS

This application is a U.S. National Stage application claiming benefit of International Application No. PCT/EP2011/073686, filed Dec. 21, 2011, and claiming benefit of German Application No. DE 10 2010 055 679.3, filed Dec. 22, 2010. The entire disclosures of both PCT/EP2011/073686 and DE 10 2010 055 679.3 are incorporated herein by reference.

### BACKGROUND

The present invention relates to a titano-silico-aluminophosphate as well as a method for its production.

Aluminosilicates (zeolites), aluminophosphates (AlPOs) and silico-aluminophosphates (SAPOs) have been known for some time in the state of the art as active catalyst components in refinery and petrochemistry. Furthermore they are used in the stationary and mobile phases of exhaust-gas purification.

Aluminosilicates (zeolites) occur in numerous different structures in nature but are also produced synthetically. Aluminosilicates (zeolites) have a high adsorption capacity and can reversibly absorb water and other low-molecular substances which, upon heating, can then be released again without their structure being damaged. However, it is not only aluminosilicates (zeolites) which display structural diversity and high adsorption capacity, but also the group of aluminophosphates. The structures of this group of substances are classified by the “Structure Commission of the International Zeolite Association” on the basis of their pore sizes according to IUPAC rules (International Union of Pure and Applied Chemistry). As microporous compounds they have pore sizes between 0.3 nm and 0.8 nm. The crystal structure and thus the size of the pores and channels formed are controlled by synthesis parameters such as pH, pressure and temperature. The porosity is further influenced by the use of templates during synthesis as well as the Al/P/(Si) ratio. They crystallize into more than two hundred different variants, into more than two dozen different structures, which have different pores, channels and cavities.

In addition to aluminosilicates and aluminophosphates there are also modified aluminosilicates and aluminophosphates. In particular the titano-aluminophosphates as well as the silico-aluminophosphates are known here. Because of the equal number of aluminium and phosphorus atoms, aluminophosphates are neutral in charge. Titano-aluminophosphates are formed starting from aluminophosphates as a result of the isomorphic exchange of phosphorus for titanium, and titano-silico-aluminophosphates (TAPSO) are formed as a result of the additional exchange of silicon. As a result of the exchange, surplus negative charges form which are balanced by the insertion of additional cations into the pore and channel system. The level of phosphorus-titanium and phosphorus-silicon substitution thus determines the number of cations required for balancing, and thus the maximum loading of the compound with positively charged cations, e.g. hydrogen or metal ions. As a result of the insertion of the cations the properties of the titano-silico-aluminophosphates (TAPSO) can be set and modified.

The framework structures of the titano-aluminophosphates are constructed from regular, three-dimensional spatial networks with characteristic pores and channels which can be linked with each other via common oxygen atoms in one, two or three dimensions.

The crystalline structures are formed from corner-connected tetrahedral units (AlO₄, PO₄, TiO₄, optionally SiO₄), each consisting of titanium, aluminium and phosphorus as well as silicon tetracoordinated with oxygen. The tetrahedra are called the primary structural units the connecting of which results in the formation of secondary structural units.

These structures contain cavities characteristic of each structure type. The titano-aluminophosphates are divided into different structures according to their topology. The crystal framework contains open cavities in the form of channels and cages which are normally occupied by water molecules and additional framework cations which can be replaced. There is one phosphorus atom for each aluminium atom, with the result that the charges cancel each other out. If phosphorus is exchanged for titanium, the titanium atoms thus form surplus negative charges which are balanced by cations. The inside of the pore system represents the catalytically active surface. The more titanium a titano-aluminophosphate contains, the denser the negative charge in its lattice and the more polar its inner surface.

The pore size and structure is influenced by the synthesis parameters as well as by the use of templates. Thus the catalytic character of a titano-aluminophosphate can be determined by the pH, the pressure, the temperature, the type of templates, the presence of seed crystals or their nature, as well as by the P/Al/Ti ratio.

In addition to titanium, phosphorus atoms can also be replaced with silicon. Their replacement produces additional negative charges which are compensated for by incorporating cations into the pores of the zeolite material.

Titano-aluminophosphates, silico-aluminophosphates and titano-silico-aluminophosphates are usually obtained by means of hydrothermal synthesis starting from reactive gels, or the individual Ti, Al, P, and optionally Si sources which are used in stoichiometric ratios. Titano-alumino-silico-phosphates (TAPSO) are produced analogously to silico-aluminophosphates (SAPO) (DE 102009034850.6). The latter can be obtained in crystalline form by adding structure-directing templates, crystallization nuclei or elements (EP 161 488 A1).

Titano-aluminophosphates are used primarily as catalysts in MTO (methanol-to-olefin conversion) processes in which, starting from methanol, a mixture of ethene and propene can be obtained.

Aluminophosphates are further used in dehydration reactions (EP 2 022 565 A1) due to their good hygroscopic properties and their high adsorption power.

Although titano-silico-aluminophosphates (EP 161 488 A1) have been known for several years already, thus far they have hardly been used in the field of catalysis.

Because of their adsorption capacity and power as a result of their microporous framework structures they are used in addition to titano-aluminophosphates primarily as adsorbers as they can adsorb many molecules on their large surface area.

A pure, non-ion-exchanged zeolite is present generally in its H form in which H⁺ ions balance the negative charges by insertion into the lattice. The zeolite acquires Brønsted acid properties as a result of the inserted protons. In addition to H⁺ other cations can also subsequently be inserted into the lattice by cation exchange. Thus these can be exchanged for example for metal cations, whereby the zeolite acquires e.g. different or improved catalytic properties.

As no surplus negative charges occur in pure aluminophosphates, pure aluminophosphates do not have any Brønsted acid properties and therefore have no acid character. Because of the lack of inserted protons a metal exchange is also not possible in the lattice, whereby there is no possibility of modifying these with metal and producing different properties.

Because of the partial replacement of phosphorus with silicon or titanium, the group of silico-aluminophosphates or titano-silico-aluminophosphates has additional negative charges. As in zeolites these can likewise be balanced by cations, for example protons. These compounds can also be exchanged for different metal cations for different technical applications.

The titano-silico-aluminophosphates differ mainly according to the geometry of the cavities which are formed by the rigid network of TiO₄/SiO₄/AlO₄/PO₄ tetrahedra, wherein the framework structure of the aluminophosphates is always formed by the linking of rings. The pore openings are composed of 8, 10 or 12 rings. They are distinguished according to pore size into small-, medium- and large-pored structures. Specific aluminophosphates have a uniform structure, e.g. a VFI or AET structure with linear channels, wherein with a different topology larger cavities can attach themselves behind the pore openings.

These materials are often modified with further components for technical applications. Thus in exhaust-gas catalysis zeolites are usually modified with transition metals and noble metals. In oxidation catalysis, noble metals are often used, whereas iron, copper, cobalt etc. are usually used for reduction catalysts.

Zeolites are usually used in the form of powders which are then shaped into extrudates, usually for stationary applications. By admixing oxidic and organic binders these are then shaped into full extrudates or honeycomb catalysts, or applied to ceramic or metallic honeycombs and shaped bodies as a washcoat.

The group of silico-aluminophosphates has a wide variety of applications. In particular SAPO-34 is important primarily in the field of catalysis. As a small-pored silico-aluminophosphate, SAPO-34 crystallizes in the known CHA structure classified according to IUPAC on the basis of the specific 8-membered structural units, and has a pore opening of 3.5 Å.

SAPO-34 has long been used as active thermally stable catalyst for the reduction of nitrogen oxides (NOₓ). For the reduction with hydrocarbons, such as e.g. propene, or also in connection with ammonia. Furthermore, the use of SAPO-34 as catalyst in the conversion of oxygen-containing hydrocarbons to olefins is also described in the literature.

In spite of good catalysis properties the use of SAPO-34 is not always possible. In the presence of water, or in the aqueous phase, SAPO-34 cannot be used because of its low hydrothermal stability as more than 70% of the structure already amorphizes and thus becomes unusable at a low thermal load of 30° C. to 50° C. In particular the amorphizing of the structure already starts during the production of catalysts in the aqueous phase. This is disadvantageous in particular as, for reasons of cost, production usually takes place from the aqueous phase.

Thus no alternative to SAPO-34 is known in the state of the art which, in addition to good catalysis properties and high adsorption capacity, also has a high hydrothermal stability, in particular over longer periods of time as are customary in industrial catalysis.

### SUMMARY

Therefore it was the object of the present invention to provide a small-pored material which has good catalysis properties, a high adsorption capacity and hydrothermal stability, in particular in aqueous solutions and in hot water-vapour atmospheres over longer periods as are customary e.g. in industrial catalysis.

According to the invention this object is achieved by a titano-silico-aluminophosphate with tetrahedrally coordinated titanium which has a free coordination site for CO.

It was surprisingly found that the titano-silico-aluminophosphate (TAPSO) according to the invention, e.g. TAPSO-34, has a higher thermal stability in aqueous phases than SAPO-34 not containing titanium. Therefore TAPSOs can be obtained by a hydrothermal method and additionally have a high structural stability in aqueous phases and in hot water-vapour atmospheres. The high stability is of great advantage in particular vis-à-vis the so-called hydrothermal stress, defined below, in particular vis-à-vis hydrothermal stress over longer periods of time in the aqueous phase, in particular in temperature ranges of from 50° C. to 100° C., and in the gas phase in temperature ranges of from 500° C. to 900° C.

### DETAILED DESCRIPTION

By “hydrothermal stress” is meant here that high temperatures prevail in the presence of water. Examples of this are the hydrothermal synthesis of chemical compounds, adsorption or desorption processes. Also meant by this is the repeated process of adsorption and desorption, as here water adsorbed via heat induction, or other low-molecular compounds, repeatedly desorb in order that water or other low-molecular compounds can be adsorbed again. Advantageously TAPSOs, in particular titanium-containing TAPSO-34, retain their structure even during a hydrothermal treatment at temperatures of more than 70° C. in the aqueous phase, whereas the structure of SAPOS, e.g. SAPO-34, is already affected at 30° C., and as of 70° C. loses its structure entirely and is present completely amorphized. TAPSOs retain their structures even at 80° C. under hydrothermal conditions. A comparison of the BET surface area showed that, in contrast to the pure SAPOs, the titano-silico-aluminophosphates have a constant BET surface area of over 630 m²/g even after a hydrothermal treatment at 80° C.

According to the invention the titano-silico-aluminophosphate contains tetrahedrally coordinated titanium. These titanium-containing silico-aluminophosphates according to the invention thereby have a much higher hydrothermal stability compared with pure silico-aluminophosphate not containing titanium, and still retain their characteristic structure even after a longer hydrothermal treatment even at higher temperatures. This is due to a stabilization by inserted tetrahedrally coordinated titanium atoms. Because of the tetrahedrally coordinated titanium atoms, titano-silico-aluminophosphates according to the invention have an extremely high stability vis-à-vis hydrothermal stress and water even at high temperatures. Repeated adsorption and desorption processes can thereby also be carried out. Because of their high long-term stability vis-à-vis water and high temperatures during repeated adsorption and desorption processes, the process costs can thus also be reduced when titano-silico-aluminophosphates are used in the presence of water for catalysis processes.

The tetrahedrally coordinated titanium of N. N. Panchenko, E. Roduner, Langmuir 21, 10545-10554 (2005) has a free coordination site for CO, whereby pentacoordinated titanium forms upon CO adsorption. As a result of the addition of CO to the tetrahedrally coordinated titanium, IR spectroscopy can be used to detect a Ti—CO stretching vibration band at 2199-2181 cm⁻¹, which is typical for meso- and microporous titano-silicates and also occurs with other titanium-containing silico derivatives. The IR band occurs only with micro- and mesoporous titano-silico materials in which the titanium atoms are inserted in the framework and are not present as isolated tetrahedra. Thus these characteristic IR bands cannot be detected in pure TiO₂ or silico-aluminophosphates not containing titanium or in silico-aluminophosphates which do contain titanium, in which titanium is not inserted in the framework. The broadening of the Ti—CO-IR band is due to the CO-coordinated environment of the titanium atom which has at least one further titanium or silicon atom in its vicinity.

The detection of the characteristic vibration band at 2192±5 cm⁻¹ in the IR spectrum is further an indication that the titano-silico-aluminophosphate according to the invention has a high Brønsted acidity. This is responsible for the catalytic properties of the titano-silico-aluminophosphate as the conversion rate in particular in acid-catalyzed catalysis processes can be increased by a high Brønsted acidity. Such a titano-silico-aluminophosphate catalyst has on its surface acid centres at which reactions or reaction steps can take place. The type and number of these acid centres has a decisive effect on the features of the reaction such as activity, selectivity or deactivation behaviour. For development and optimization of chemical processes with acid heterogeneous catalysts it is therefore often necessary to investigate the Brønsted acidity of these catalysts. If a titano-silico-aluminophosphate is present in its H form then the number of Brønsted acid centres is defined by the number of protons.

The Brønsted acidity is defined by the number of free negative charges in the framework of the titano-silico-aluminophosphates, which is determined by the (Si+Ti)/Al ratio. Because there is no valence electron the Al atom has a higher electron affinity than the Si atom or Ti atom, which leads to the addition of a proton to an AlO₄⁻ tetrahedron and the Brønsted acidity being increased.

As a result of the addition of the proton, the O—H bond at the Al is weakened, whereby H₂O can be split off at increased temperatures. Unsaturated Al³⁺ ions which, as strong electron acceptors, represent strong Lewis acid centres thereby form. These tricoordinated (and thus strongly Lewis acid) aluminium atoms are no longer part of the periodically structured crystal lattice, which is why this process is also called dealuminization. The number of Brønsted acid centres decreases as the number of Lewis acid centres increases. As strong Lewis acids, these centres can also enter into Lewis acid-base reactions, whereby the properties of the titano-silico-aluminophosphates as catalyst can be changed.

The acidity of titano-silico-aluminophosphates is determined not only by the number of aluminium atoms in the framework but also on the basis of the negatively charged AlO_{4/2}⁻ tetrahedra, the neutral SiO_{4/2} tetrahedra, the neutral TiO_{4/2} tetrahedra and the positively charged PO_{4/2}⁺ tetrahedra. Because of the titano-silico-aluminophosphates with Brønsted acidity desired for the catalysis, a negatively charged framework is required which is formed by replacing phosphorus with silicon or titanium. One positive charge per replaced phosphorus atom is thereby lacking, with the result that a negative surplus charge results overall. If the charge is equalized by protons, a titano-silico-aluminophosphate with Brønsted acidity is present. Thus the higher the Brønsted acidity, i.e. the more acid centres available for catalysis, the higher the catalytic activity of the titano-silico-aluminophosphate.

However, as Ti, like Si, is inserted into the framework as tetrahedra neutral in charge, the Brønsted acidity in titano-silico-aluminophosphates is determined by the replacement of phosphorus with titanium/silicon. Because of the formation of a pentacoordinated titanium by CO addition (adsorption), the Brønsted acidity can thus be determined on the basis of the adsorbed quantity of CO by means of IR spectroscopy. The acid strength of the titano-silico-aluminophosphate can thereby be indirectly determined.

The framework structure is thus stabilized and offers no possibility of being affected by water, and thus leads to an extremely high stability vis-à-vis hydrothermal stress.

The Ti—CO-IR band has an intensity of 0.005 to 0.025. This characteristic IR band at 2192±5 cm⁻¹ is shown in FIG. 1. This Ti—CO-IR band, marked with an arrow, is to be regarded as a shoulder as the adjacent CO band for CO adsorbed on silicon at 2173 cm⁻¹±5 cm⁻¹ is much more intensive. According to the invention it has been shown that the improvement in hydrothermal stability is associated with a specific intensity of 0.005-0.025 in the IR spectrum. In order that the titano-silico-aluminophosphate has the desired hydrothermal stability the intensity is to be at least 0.005, preferably 0.016±0.005.

The titano-silico-aluminophosphate according to the invention contains a proportion of from 0.06 to 5 wt.-% titanium, in other embodiments from 0.15 to 4 wt.-%, further from 0.15 to 3.6 wt.-%, or 0.15 to 3 wt.-% in the framework. It has been shown that in particular a proportion as of 0.06 wt.-% in the framework of the titano-silico-aluminophosphates leads to an increase in the hydrothermal stability. If the proportion is smaller, then the BET surface area of the titano-silico-aluminophosphate which serves to determine the intact framework structure is more strongly amorphized after a hydrothermal treatment than if the proportion of titanium lies in a range between 0.06 and 5 wt.-%.

The titano-silico-aluminophosphate according to the invention has a Ti/Si/(Al+P) ratio of 0.01:0.01:1 to 0.2:0.2:1. Titano-silico-aluminophosphates which, in addition to a specific ratio of Si:P by replacing phosphorus with silicon in the framework structure, also have a specific proportion of titanium in the framework structure, are particularly suitable. Titano-silico-aluminophosphates with the ratio according to the invention are characterized by a hydrothermal long-term stability with a high resistance to hydrothermal stress, wherein the adsorption capacity, e.g. for CO, also remains high.

Titano-silico-aluminophosphate according to the invention can be used as catalyst because of the high adsorption capacity, or for the adsorption of water in drying, for example in dishwashers, dryers, heat exchangers or air conditioning units etc. The adsorption capacity determines how many molecules can be absorbed into the framework of the titano-silico-aluminophosphate according to the invention.

The titano-silico-aluminophosphate according to the invention has a (Si+Ti)/(Al+P) molar ratio of from 0.01 to 0.5 to 1, preferably from 0.02 to 0.4 to 1, even more preferably from 0.05 to 0.3 to 1 and most preferably from 0.07 to 0.2 to 1, whereby the stability vis-à-vis hydrothermal stress is particularly high. This can be seen from the BET surface area after hydrothermal stress which is much higher compared with SAPO-34 (Table 1).

Because of the phosphorus atoms, replaced with titanium atoms or silicon atoms, the titano-silico-aluminophosphate according to the invention has negative charges which are compensated for by cations. The catalytic properties of the titano-silico-aluminophosphates are defined or changed by the replacement with the metal cations. The metal cations present inside the framework structure give the structure the catalytic properties.

The ion exchange of H⁺ or Na⁺ for a metal cation can be carried out both in the liquid and also in the solid phase. Gas-phase exchange processes are also known which are too laborious for industrial processes. The disadvantage with the current state of the art is that, with solid ion exchange, a defined quantity of metal ions can be inserted into the framework of the titano-silico-aluminophosphates but no homogeneous distribution of the metal ions takes place. With an ion exchange carried out in liquid, usually in the aqueous phase, on the other hand a homogeneous metal-ion distribution in the titano-silico-aluminophosphate can be achieved. Aqueous ion exchange is disadvantageous with small-pored zeolites because the hydration sheath of the metal ions is too big for the metal ions to be able to penetrate the small pore openings and the replacement rate is thus very low. In addition to the named methods, the doping or modifying can be carried out with one or more metal cations by aqueous impregnation or the incipient wetness method. These doping or modifying methods are known in the state of the art. It is particularly preferred that the doping or modifying is carried out by means of one or more metal compounds by aqueous ion exchange, wherein both metal salts and metal complexes are used as metal-ion sources.

Surprisingly, titano-silico-aluminophosphates according to the invention have a high hydrothermal stability up to 900° C. This is particularly advantageous for applications in catalysis processes which are carried out in the presence of water and at higher temperatures. The silico-aluminophosphates not containing titanium known from the state of the art have only a very low stability in the aqueous phase and already amorphize at low temperatures.

This increased hydrothermal stability is particularly advantageous because in particular the hydrothermal stability is important at high and low temperatures, as already at a low desorption temperature of 20° C. to 100° C. titano-silico-aluminophosphates are regenerated again, preferably at a temperature of 30° C. to 90° C., more preferably at a temperature of 40° C. to 80° C. Because they do not display any tendency to amorphization like silico-aluminophosphates, but have a much higher structure stability at a lower desorption temperature compared with zeolites or aluminophosphates, several cycles of adsorbing and desorbing can thus be passed through without the adsorption material needing to be replaced. Furthermore, the energy costs necessary for regenerating the adsorbent are reduced. In the hydrothermal long-term stress test it has been shown that, compared with silico-aluminophosphates at 30° C., titano-silico-aluminophosphates according to the invention at 90° C. over longer periods of time withstand a treatment with water without amorphizing, i.e. in particular reduction of the BET surface area or structure deformation.

The titano-silico-aluminophosphates according to the invention are selected from TAPSO-5, TAPSO-8, TAPSO-11, TAPSO-16, TAPSO-17, TAPSO-18, TAPSO-20, TAPSO-31, TAPSO-34, TAPSO-35, TAPSO-36, TAPSO-37, TAPSO-40, TAPSO-41, TAPSO-42, TAPSO-44, TAPSO-47, TAPSO-56. According to the invention particularly the use of microporous titano-silico-aluminophosphates with CHA structure is suitable. Particularly preferred are TAPSO-5, TAPSO-11 or TAPSO-34, quite particularly TAPSO-34, as these have a particularly high hydrothermal stability vis-à-vis water. Particularly suitable are TAPSO-5, TAPSO-11 and TAPSO-34 also because of their good properties as catalyst in different processes, due to their microporous structure, whereby they are also very suitable as adsorbents because of their high adsorption capacity. Moreover, they also have a low regeneration temperature, as they already reversibly release adsorbed water or adsorbed other small molecules at temperatures between 30° C. and 90° C.

Regenerable means that the water-containing adsorbent reversibly releases the adsorbed water under the action of heat. The titano-silico-aluminophosphate is thereby recovered and can be used again for adsorption or in catalytic processes.

Metal-exchanged titano-silico-aluminophosphate according to the invention has a metal proportion which lies in the range of from 1 wt.-% to 20 wt.-% relative to the total weight of the titano-silico-aluminophosphate. The catalytic properties are determined by the metal exchange, whereby titano-silico-aluminophosphates, in particular as a result of their hydrothermal long-term stability, become suitable materials for catalysis processes in the presence of water at high temperatures. It is particularly advantageous that the metal exchange can be carried out in the liquid phase, i.e. in the aqueous phase of microporous and small-pored titano-silico-aluminophosphates, without the framework structure being damaged. Higher exchange rates compared with the state of the art thereby result, whereby a higher proportion of metal can be incorporated into the framework structure of the titano-silico-aluminophosphate. Additionally, an even distribution of the metal ions in the framework of the titano-silico-aluminophosphates is made possible by an aqueous metal exchange, starting from metal salt solutions, etc., wherein typically a metal proportion of 0.01-20 wt.-% is advantageous.

According to the invention titano-silico-aluminophosphates therefore contain, in developments of the invention, at least one further metal, selected from lithium, sodium, potassium, magnesium, calcium, strontium, barium, scandium, titanium, vanadium, chromium, manganese, iron, nickel, copper, zinc, gallium, germanium, cobalt, boron, rubidium, yttrium, zirconium, niobium, molybdenum, ruthenium, rhodium, palladium, silver, cadmium, indium, tin, lanthanum, hafnium, tantalum, tungsten, rhenium, osmium, iridium, platinum, gold, and/or bismuth.

By the term “metal exchange” is also meant, according to the invention, a doping with metal or semimetal. It means the same, whether the exchange takes place in the framework and metal ions were integrated into the structure, or whether the exchange was carried out subsequently and only cations X are replaced with other metal cations M.

According to the invention the titano-silico-aluminophosphates can also be present doped, i.e. in which metal is inserted into the framework. It has proven particularly advantageous to dope with iron, manganese, copper, cobalt, chromium, zinc and nickel. Particularly suitable are FeTAPSO, MnTAPSO, CuTAPSO, CrTAPSO, ZnTAPSO, CoTAPSO and NiTAPSO.

Particularly suitable are microporous MTAPSOs (M=Mg, Mn, Cu, Cr, Zn, Co, Ni) such as MTAPSO-5, MTAPSO-8, MTAPSO-11, MTAPSO-16, MTAPSO-17, MTAPSO-18, MTAPSO-20, MTAPSO-31, MTAPSO-34, MTAPSO-35, MTAPSO-36, MTAPSO-37, MTAPSO-40, MTAPSO-41, MTAPSO-42, MTAPSO-44, MTAPSO-47, MTAPSO-56.

Particularly preferably MTAPSO-5, MTAPSO-11 or MTAPSO-34 are used, wherein M is defined as above. This is particularly advantageous as by the insertion of one or more further metals, the adsorption properties and the hydrothermal stability of the titano-silico-aluminophosphates is usually further increased.

Surprisingly titano-silico-aluminophosphates according to the invention which are used in a heat exchanger module according to the invention have a high hydrothermal stability up to 900° C. This is particularly advantageous because in particular the hydrothermal stability is important at high and low temperatures, as titano-silico-aluminophosphates are already regenerated again at a low desorption temperature of from 20° C. to 100° C., preferably at a temperature of from 30° C. to 90° C., more preferably at a temperature of from 40° C. to 80° C. Because they do not display any tendency to amorphization like silico-aluminophosphates, but have a much higher structure stability at lower desorption temperatures compared with zeolites or aluminophosphates, a very large number of cycles of adsorbing and desorbing can thus be passed through without the adsorption material needing to be replaced. Furthermore, the energy costs necessary for regenerating the adsorbent are reduced.

The (primary) crystallite sizes of the titano-silico-aluminophosphates according to the invention are between 0.1 μm and 10 μm. It is particularly advantageous if the crystallite size is approximately 0.5-3 μm. The material can thus be used directly without further processing, such as grinding, etc. However, grinding processes can be carried out with the help of ball mills, planetary mills, jet mills etc. without the material being damaged.

The titano-silico-aluminophosphate can be used as extrudate, binder-containing or binder-free granular material, pellets or compacts.

Advantageously, the titano-silico-aluminophosphate can also be present in a coating on a shaped body. It is advantageous if the material is already present in the form of small crystallites. The shaped body can assume any geometric shape, such as e.g. hollow articles, sheets, grids or honeycombs. The application is usually carried out via a suspension (washcoat) and can be carried out with any further method known per se to a person skilled in the art. Furthermore, the shaped body can also consist completely of a titano-silico-aluminophosphate which can be obtained by pressing, optionally accompanied by the addition of a binder and/or excipient, and drying.

The use of the titano-silico-aluminophosphate as shaped body in catalytic processes is particularly advantageous as the material can thus be integrated in space-saving manner and also makes easy handling possible.

It is furthermore advantageous if the titano-aluminophosphate is present as bulk granular material or a shaped body in the form of small spheres, cylinders, beads, filaments, strands, small sheets, cubes, or agglomerates, as the adsorptive surface of the titano-silico-aluminophosphate is thus increased, which makes possible a particularly efficient catalysis, or adsorption of water vapour and water.

The use as shaped body is advantageous as the titano-silico-aluminophosphates can thus be used in space-saving manner in different catalysis processes, adsorbents or as heat exchanger material.

The titano-silico-aluminophosphate can also be used as a fixed bed or bulk material feed. A bulk titano-silico-aluminophosphate feed or titano-silico-aluminophosphate incorporated in the fixed bed is particularly suitable as handling is easier.

The object of the present invention is further achieved by a method for producing the titano-silico-aluminophosphate according to the invention comprising the steps of
a) providing an aqueous synthetic gel mixture containing at least an aluminium source, a phosphorus source, a silicon source, a template and a further titanium source,
b) stirring for several hours at a temperature of 180° C.,
c) filtering and drying at a temperature of 100° C.,
d) calcining at a temperature of 550° C.,
e) obtaining a titanium-containing silico-aluminophosphate.

The method according to the invention for producing a titano-silico-aluminophosphate is carried out starting from a synthetic gel mixture in aqueous medium. The method can also be carried out under pressure in an autoclave. The synthetic gel mixture contains an aluminium source, a phosphorus source, a silicon source, a template and a titanium source. In some embodiments of the invention a titanium-containing silicon source is used as titanium source. The components are combined in aqueous solution, wherein a synthetic gel mixture is obtained. The synthetic gel mixture is reacted accompanied by stirring for 12 to 100 hours, preferably 24-72 hours, at a temperature of from 150° C. to 350° C., preferably at 160° C. to 185° C., then filtered, and dried at a temperature of 100° C. The obtained titano-silico-aluminophosphate is calcined at a temperature of from 400° C. to 600° C., preferably 550° C., wherein crystalline titanium-containing silico-aluminophosphate is obtained.

Titanium oxygen compounds or titanium metal organic compounds such as TiO₂, TiOSO₄, Ti-tetra-isopropylate, tetraethyl orthotitanate are used as titanium source.

Aluminium oxide, sodium aluminate, aluminium hydroxide, or an aluminium salt preferably serves as aluminium source.

Silicon dioxide, sodium silicate, a silicon sol, silicic acid, colloidal silicic acid, precipitated silicic acid, silicon-doped titanium oxide or pyrophoric silicic acid is preferably used in the method according to the invention as silicon source.

Phosphoric acid, a metal phosphate, hydrogen phosphate or dihydrogen phosphate is preferably used according to the invention as phosphorus source.

Various ionic templates can be used in the method according to the invention, selected from the group of tetramethyl ammonium, tetraethyl ammonium, tetrapropyl ammonium, tetrabutyl ammonium hydroxides and bromides, di-n-propylamine, tri-n-propylamine, triethylamine, triethanolamine, piperidine, cyclohexylamine, 2-methylpyridine, N,N-dimethylbenzylamine, N,N-dimethylethanolamine, choline, N,N′-dimethylpiperazine, 1,4-diazabycyclo(2,2,2)octane, N-methyldiethanolamine, N-methylethanolamine, N-methylpiperidine, 3-methylpiperidine, N-methylcyclohexylamine, 3-methylpyridine, 4-methylpyridine, quinuclidine, N,N′-dimethyl-1,4-diazabicyclo(2,2,2)octane, di-n-butylamine, t-butylamine, ethylene diamine, pyrrolidine, 2-imidazolidone. In some embodiments of the invention in particular tetraethylammonium hydroxide is used.

In a development according to the invention of the method preferably a titanium source is used, such as e.g. TiO₂, which contains 0.5 to 25 wt.-% silicon dioxide. Preferably the titanium source contains 5 to 20 wt.-% silicon. The hydrothermal stability is determined by the proportion of titanium in the titano-silico-aluminophosphates according to the invention as the hydrothermal long-term stability also decreases with the proportion of titanium in the structure.

According to the method according to the invention a titano-silico-aluminophosphate is obtained which has a Si/Ti ratio of from 0.02 to 40.

The Si/Ti ratio of the silico-aluminophosphate according to the invention is preferably in the range of from 0 to 20, more preferably in the range of from 0.5 to 10, even more preferably in the range of from 0.5 to 8. The Al/P ratio is preferably in the range of from 0.9 to 1.8, more preferably 1 to 1.6 and most preferably in the range of from 1.3 to 1.5.

The titano-silico-aluminophosphate obtained according to the method according to the invention has a Si/Al ratio of from 0.05 to 0.3.

The titano-silico-aluminophosphate according to the invention has a much higher acid strength than titano-silico-aluminophosphates known from the state of the art, as no Na₂O is used in the method for its production. Na₂O is known for its extremely high base strength. If sodium oxide is used for the synthesis the acid strength of the titano-silico-aluminophosphate is reduced, which, because of acid-base reactions, leads to a reduction of the acid centres, i.e. the catalytic centres, with the result that the catalytic effect which is based on the acid strength of the titano-silico-aluminophosphate decreases. Thus the titano-silico-aluminophosphate obtainable according to the method described above has a much higher acid strength and thus a much higher catalytic activity, in particular in acid-catalytic processes.

To illustrate the present invention and its advantages it is described by means of the following FIGURE and examples without these being understood to be limiting.

### BRIEF DESCRIPTION OF THE DRAWINGS

FIG. 1 is a graph of the IR bands of TAPSO-34, SAPO-34 and a mixture of SAPO-34 and TiO₂.

### METHOD SECTION

The methods and equipment used are listed below but are not to be understood as limiting.

### Determination of the BET Surface Area:

The BET surface area was determined according to DIN 66131 (multi-point determination), as well as according to DIN ISO 9277 (European Standard issued 2003-05) in accordance with the determination of the specific surface area of solids by gas adsorption according to the BET method (according to Brunauer, S; Emett, P.; Teller, E. J. Am. Chem. Soc. 1938, 60, 309.).

Determination took place using a Gemini from Micromeritics, with reference to the manufacturer's instructions.

The X-ray diffractometry took place using a D4Endeaver from Bruker, with reference to the manufacturer's instructions.

To determine the IR bands a Thermo Nicolet 4700 FTIR spectrometer with MCT detector from Thermo Scientific was used according to the manufacturer's instructions.

For the synthesis a stainless-steel autoclave (0.5 l volume) from Juchheim GmbH was used.

For the synthesis example hydrargillite (aluminium hydroxide SH10) from Aluminium Oxid Stade GmbH, Germany, was used.

Furthermore, silica sol (Köstrosol) with 1030.30% silicon dioxide from CWK Chemiewerk Bad Köstritz GmbH, Germany, was used.

The titanium dioxide doped with silicon TiO₂ 545 S was obtained from Evonik, Germany.

For the comparison example, SAPO-34 from Süd-Chemie AG was used.

### Example 1

### Production of TAPSO-34 According to the Invention

100.15 parts by weight deionized water and 88.6 parts by weight hydrargillite (aluminium hydroxide SH10) were mixed. 132.03 parts by weight phosphoric acid (85%) and 240.9 parts by weight TEAOH (tetraethylammonium hydroxide) (35% in water), and then 33.5 parts by weight silica sol and 4.87 parts by weight silicon-doped titanium dioxide were added to the obtained mixture, with the result that a synthesis mixture with the following composition was obtained:
Al₂O₃: P₂O₅:0.3 SiO₂: 0.1 TiO₂:1 TEAOH:35 H₂O

The synthetic gel mixture with the above composition was transferred into a stainless-steel autoclave. The autoclave was stirred and heated to 180° C., wherein this temperature was maintained for 68 hours. After cooling the obtained product was filtered off, washed with deionized water and dried in the oven at 100° C. An X-ray diffractogram of the obtained product showed that the product was pure TAPSO-34 according to the invention. The elemental analysis revealed a composition of 1.5% Ti, 2.8% Si, 18.4% Al and 17.5% P, which corresponds to a stoichiometry of Ti_{0.023}Si_{0.073}Al_{0.494}P_{0.410}. According to an REM analysis (raster electron microscopy) of the product its crystal size was in the range of from 0.5 μm to 2 μm.

The obtained product was then calcined at 550° C. for 1 h. The titano-silico-aluminophosphate according to the invention has a CO—Ti vibration band in the IR spectrum at 2192±5 cm⁻¹.

### Example 2

### Hydrothermal Long-Term Stress Test

A titano-silico-aluminophosphate according to the invention (TAPSO-34) with 3.4 wt.-% Ti (obtained as in Example 1 with correspondingly matched composition of the synthetic gel), a titano-silico-aluminophosphate not according to the invention (TAPSO-34) with 0.5 wt.-% Ti and a silico-aluminophosphate not containing titanium (SAPO-34) were treated with water to determine the hydrothermal long-term stability over a longer period of time at different temperatures.

Small-pored molecular sieves with CHA structure have high adsorption capacities but, depending on the titanium proportion in the structure, have different hydrothermal stability. Therefore, in addition to the titano-silico-aluminophosphate (TAPSO-34) according to the invention also a titano-silico-aluminophosphate not according to the invention (TAPSO-34), with low titanium proportion and a silico-aluminophosphate not containing titanium (SAPO-34) were selected and examined in the hydrothermal long-term stress test according to the same method.

A hydrothermal long-term stress test was carried out in order to show that the structure of the titano-silico-aluminophosphate according to the invention withstands a treatment with and in water at 30° C., 50° C., 70° C. and 90° C. for 72 h, in contrast to the structure of the titano-silico-aluminophosphates not according to the invention and the silico-aluminophosphates not containing titanium. This was determined with the help of the BET surface area in order to thus obtain information about the degree of the amorphization with regard to the structure deformation.

### Test Procedure:

For the hydrothermal long-term stress test, respectively the same quantity of TAPSO-34 according to the invention, TAPSO-34 not according to the invention and SAPO-34 not containing titanium were treated at 30° C., 50° C., 70° C. and 90° C. each for 72 h in water. The material was then filtered off, dried at 120° C. and the BET surface area ascertained. The TAPSO-34 not according to the invention and the SAPO-34 not containing titanium display, even without treatment, a lower BET surface area than a comparable TAPSO-34 according to the invention. While TAPSO-34 according to the invention displays only a small amount of damage to the BET surface area by water depending on the temperature, and even after a treatment at 90° C. over a period of 72 h contains more than 50% of the original BET surface area, the BET surface area of the TAPSO-34 not according to the invention and the SAPO-34 not containing titanium already decreases after a treatment with water at 30° C. over a period of 72 h, to 80% or 77% of the original BET surface area. In contrast to this, the TAPSO-34 according to the invention still has over 99% of the original BET surface area even after a 72-hour treatment with water at 30° C. After a treatment with water over 72 h at 50° C. the structure of the TAPSO-34 not according to the invention and of SAPO-34 is almost completely destroyed, after 72 h at 70° C. barely any crystalline structure remains, and after a treatment at 90° C. both TAPSO-34 not according to the invention as well as SAPO-34 not containing titanium are completely amorphized and the typical crystalline structure is completely destroyed.

The hydrothermal long-term stress test thus shows that TAPSOs not according to the invention and SAPOs not containing titanium already lose their structure after a 72-hour treatment at 50° C. and already become amorphous at 70° C. In contrast, titano-silico-aluminophosphates (TAPSOs) according to the invention display an enormous resistance to hydrothermal long-term stress. Even after a long-term stress test with and in water at 70° C. TAPSOs according to the invention retain their structure, and display an amorphization of 50% only after a treatment at 90° C. (see Table 1).

The hydrothermal long-term stress test thus clearly shows that only titano-silico-aluminophosphates according to the invention, in which a specific proportion of titanium between 0.06 and 5 wt.-% is inserted in the framework, also display such a high stability in the hydrothermal environment. Such titano-silico-aluminophosphates according to the invention also display a corresponding, slightly broadened band at 2192±5 cm⁻¹ in the IR. If this band is missing, as with titano-silico-aluminophosphates not according to the invention or silico-aluminophosphates not containing titanium, the structure thus already amorphizes at low temperatures due to hydrothermal stress.

TABLE 1
Hydrothermal long-term stress test of TAPSO-34 according
to the invention, TAPSO-34 not according to the invention and
SAPO-34 not containing titanium in respect of the BET surface area
after hydrothermal treatment depending on the temperature.

| Treatment | TAPSO-34, | TAPSO-34, | SAPO-34, |
|---|---|---|---|
| temperature/° C. | Ti = 3.4 wt.-% | Ti = 0.05 wt.-% | Ti = 0 wt.-% |
| Untreated | 632 | 597 | 557 |
| 30 | 626 | 470 | 429 |
| 50 | 619 | 214 | 108 |
| 70 | 604 | 103 | 8 |
| 90 | 320 | 7 | 0.5 |

### Example 3

### IR Spectroscopy

To determine the titanium position in the lattice the titano-silico-aluminophosphate according to the invention was examined with IR spectroscopy. Because the hydrothermal stability is increased or defined by inserting the titanium atoms into the framework of the titano-silico-aluminophosphate, the increased hydrothermal stability of the titano-silico-aluminophosphate can be determined by determining the inserted titanium in the framework structure.

The titanium atoms are determined by means of indirect determination by adsorption of CO at the free binding site of the tetrahedrally coordinated titanium, accompanied by the formation of a pentahedrally coordinated titanium. After a CO adsorption of the titano-silico-aluminophosphate according to the invention (TAPSO-34) a characteristic CO—Ti vibration band can be detected at 2192±5 cm⁻¹ in the IR spectrum.

To determine the increase in stability of comparable substances, SAPO-34 not containing titanium and a mixture consisting of SAPO-34 not containing titanium and 3.4 wt.-% TiO₂ (anatase) is likewise examined by means of IR spectroscopy after CO adsorption. As SAPO-34 not containing titanium and TAPSO-34 according to the invention have the same structure, this was chosen as comparison substance. As further comparison substance the mixture of SAPO-34 not containing titanium and TiO₂ was examined with the same method in order to show that there is no increase in the stability from titanium atoms not inserted into a framework structure, which can be shown by a missing characteristic IR band at 2192±5 cm⁻¹.

### Test Procedure:

The powdery samples of TAPSO-34 according to the invention, SAPO-34 not containing titanium and a mixture consisting of SAPO-34 not containing titanium and 3.4 wt.-% TiO₂ were pressed into self-supporting tablets with a diameter of 13 mm and a weight of from 10 to 20 mg with a pressure of approx. 0 to 3 metric tonnes. The FTIR measurements of adsorbed carbon monoxide were recorded using a Thermo Nicolet 4700 spectrometer with MCT detector. The apparatus had a specially designed high-vacuum system with connected low-temperature cell (window material ZnSe). The IR spectra were recorded, or determinations of the CO load carried out, in transmission mode with a resolution of 4 cm⁻¹ at a range of from 400 to 4000 cm⁻¹ and with 128 scans. The sample was activated in high vacuum (max. 1×10⁻⁵ mbar) for 2 h at a temperature of 450° C. The cell was then cooled to −196° C. with the help of liquid nitrogen. After this, carbon monoxide was adsorbed until a pressure of 10 mbar was established. The cell was then evacuated again gradually until no more CO bands were visible or a constant state had been established. Before every spectrum a constant quantity of helium was passed into the cell to ensure a constant sample temperature.

The quantity of the CO adsorbed on the titanium was determined by integration of the surface of the CO band (at 2192 cm⁻¹). For this, the spectrum of the TAPSO-34 was normalized to the specific surface area of the reference sample SAPO-34.

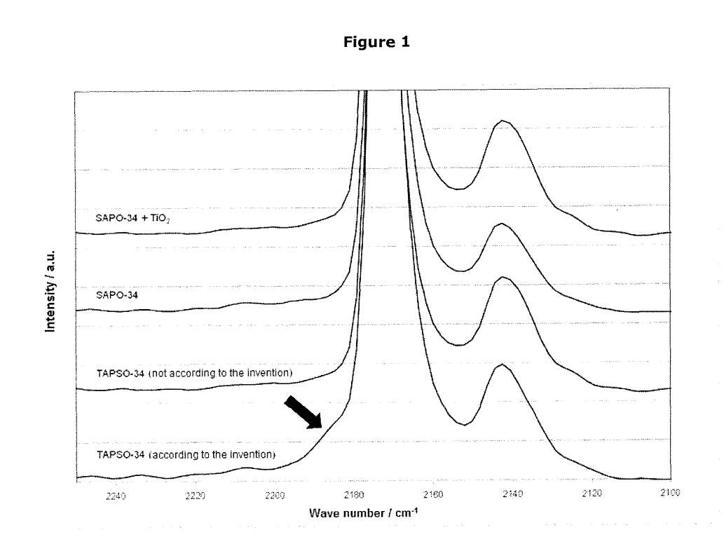

The IR spectra of TAPSO-34 (according to the invention and not according to the invention), SAPO-34 and the mixture of SAPO-34 and TiO₂ are given in FIG. 1.

It has been shown that only the titano-silico-aluminophosphate according to the invention has a CO-IR band in the IR spectrum at 2192±5 cm⁻¹, which can be attributed to tetrahedrally coordinated titanium with free coordination site for CO. The characteristic IR band at 2192±5 cm⁻¹ results from a CO—Ti stretching vibration which is characteristic of tetrahedral titanium inserted into the framework, and thus cannot be found in either SAPO-34 not containing titanium or in SAPO-34 not containing titanium mixed with TiO₂. The broadening of the vibration band results from the first or the second coordination sphere of the titanium.

TABLE 2
Determination of the relative intensity and the relative
area of the CO band at the titano-silico-aluminophosphate
according to the invention (TAPSO-34), at the titano-silico-
aluminophosphate not according to the invention (TAPSO-34),
at the SAPO-34 not containing titanium and the SAPO-34 not
containing titanium mixed with TiO₂.

| | Relative | Relative | | BET |
|---|---|---|---|---|
| | intensity of the | area of the | | surface |
| | CO band | CO band | Titanium/wt.-% | area m²/g |
| TAPSO-34 | 0.0158 | 0.114 | 3.4 | 320 |
| (according | | | | |
| to the | | | | |
| invention) | | | | |
| TAPSO-34 | 0 | 0 | 0.05 | 7 |
| (not | | | | |
| according | | | | |
| to the | | | | |
| invention) | | | | |
| SAPO-34 | 0 | 0 | — | 0.5 |
| SAPO-34 | 0 | 0 | 3.4 | 0.5 |
| with TiO₂ | | | | |

Unlike the titano-silico-aluminophosphate according to the invention, the titano-silico-aluminophosphate not according to the invention has only a very small proportion of titanium in the framework.

The comparison substances were examined with the same method. It was shown that in the SAPO-34 not containing titanium, and also in the TiO₂ mixed with SAPO-34 no CO band is observed at 2192 cm⁻¹ and therefore no Ti⁴⁻ centres are present.

### Example 4

### Adsorption of Water on Titano-Silico-Aluminophosphate According to The Invention (TAPSO-34)

Because of the high adsorption capacity the titano-silico-aluminophosphate according to the invention is used as catalyst or to adsorb water in drying.

To determine the adsorption capacity the titano-silico-aluminophosphate according to the invention (TAPSO-34), a titano-silico-aluminophosphate not according to the invention (TAPSO-34) and a silico-aluminophosphate (SAPO-34) not containing titanium were examined with the following method.

### General Part of the Test Description:

The adsorption capacity of a titano-silico-aluminophosphate according to the invention (TAPSO-34), a titano-silico-aluminophosphate not according to the invention (TAPSO-34) and a silico-aluminophosphate (SAPO-34) not containing titanium were examined depending on the treatment temperature in a heatable pressure chamber filled with water vapour.

For this, the water-vapour pressure in the pressure chamber was set at 20 mbar (at 20° C.) and the adsorbed water of the material treated at different temperatures (30° C., 50° C., 70° C. or 90° C.) was measured. Table 3 shows how TAPSO-34 according to the invention behaves compared with TAPSO-34 not according to the invention and SAPO-34 not containing titanium in respect of a water adsorption capacity depending on the ambient temperature.

TABLE 3

| Treatment | TAPSO-34, | TAPSO-34, | SAPO-34, |
|---|---|---|---|
| temperature/° C. | Ti = 3.4 wt.-% | Ti = 0.05 wt.-% | Ti = 0 wt.-% |
| Untreated | 34.9 | 33.2 | 31.2 |
| 30 | 34.3 | 27.2 | 24.0 |
| 50 | 34.0 | 12.1 | 6.5 |
| 70 | 33.5 | 6.7 | 1.9 |
| 90 | 20.2 | 1.2 | 0.8 |

The temperature was set in the pressure chamber with a thermostat and only when the temperature had been held constant for 10 min was a corresponding quantity of adsorbent added to the pressure chamber via a corresponding valve.

It was shown that a different quantity of water is adsorbed depending on the ambient temperature.

### Example 5 with TAPSO-34 According to the Invention

In embodiment example 5 TAPSO-34 according to the invention (with 3.4 wt.-% Ti) was used.

The series of tests at 20 mbar water vapour pressure show for TAPSO-34, which was treated at temperatures of from 23 to 70° C., that a lot of water is adsorbed and the quantities of adsorbed water (Table 3) is reduced only as of a temperature of 70° C. Here, the values of the adsorbed water were in a range of from 33.5 wt.-% to approx. 34.9 wt.-% relative to the total weight of the TAPSO-34 according to the invention.

As of a temperature of 70-75° C. the quantity of water decreases slightly, but at 90° C. still over 50% of the initial quantity of water is adsorbed.

The adsorption capacity of maximum 34.9% at the start decreases as temperature increases, as at temperatures as of 70° C. the BET surface area, i.e. the active, adsorbing surface of the titano-silico-aluminophosphate, amorphizes slowly. However, titano-silico-aluminophosphates according to the invention are so stable even in the presence of water that even at a temperature of 90° C. still more than 50% of the surface is intact and this can therefore adsorb water (see Table 1).

### Comparison Example

In the comparison example a corresponding quantity of titano-silico-aluminophosphate not according to the invention (TAPSO-34) and of silico-aluminophosphate (SAPO-34) not containing titanium was used in each case. The TAPSO-34 not according to the invention and the SAPO-34 not containing titanium were chosen to compare the adsorption capacity with that of the adsorption capacity of the titano-silico-aluminophosphate according to the invention (TAPSO-34) depending on the titanium inserted in the structure.

The comparison examples of the TAPSO-34 not according to the invention and of the SAPO-34 not containing titanium show (Table 2) that the adsorption capacity is very strongly influenced by the treatment temperature. Already as of a temperature of 30° C. the adsorption power for water vapour decreases. With a material which was treated at a temperature of 70° C. hardly any more water is adsorbed on the surface of the TAPSO-34 not according to the invention and of the SAPO-34 not containing titanium. SAPO-34 which was treated at 90° C. does not adsorb any more water as the structure is completely amorphized, whereas TAPSO-34 not according to the invention has yet less adsorption power after treatment at 90° C. (see also Table 3).

A constant adsorption capacity, also depending on the treatment temperature, is thus achieved by the proportion, according to the invention, of tetrahedrally-coordinated titanium in the framework structure in titano-silico-aluminophosphates according to the invention. This can be detected by a characteristic IR-Ti vibration band and is shown by a higher temperature stability of the structure. If there is too little titanium in the framework structure, the adsorption power is retained for longer compared with pure silico-aluminophosphates, but likewise decreases markedly depending on the treatment temperature.

### Comparison Example 1

### Production of TAPSO-34 not According to the Invention

76.41 parts by weight deionized water and 73.84 parts by weight hydrargillite (aluminium hydroxide SH10) were mixed. 110.04 parts by weight phosphoric acid (85%) and 200.81 parts by weight TEAOH (tetraethylammonium hydroxide) (35% in water), as well as then 38.09 parts by weight silica sol and 0.81 parts by weight silicon-doped titanium oxide is added to the obtained mixture, with the result that a synthesis mixture with the following composition was obtained:

A synthetic gel mixture with the following molar composition was obtained:
Al₂O₃: P₂O₅:0.4 SiO₂: 0.02 TiO₂:1 TEAOH:35 H₂O

The synthetic gel mixture with the above composition was transferred into a stainless-steel autoclave. The autoclave was stirred and heated to 180° C., wherein this temperature was maintained for 68 hours. After cooling the obtained product was filtered off, washed with deionized water and dried in the oven at 100° C. An X-ray diffractogram of the obtained product showed that the product was a TAPSO-34. The elemental analysis revealed a composition of 0.05% Ti, 3.7% Si, 17.9% Al and 17.2% P which corresponds to a stoichiometry of Ti_{0.001}Si_{0.097}Al_{0.491}P_{0.411}. The thus-obtained titano-silico-aluminophosphate not according to the invention has, with 0.01% Ti, a lower proportion of titanium than the minimum proportion of the titano-silico-aluminophosphate according to the invention of 0.2 wt.-%. According to an REM analysis (raster electron microscopy) of the product its crystal size was in the range of from 0.5 μm to 2.5 μm.

The obtained product was then calcined at 550° C. for 1 h.

### Comparison Example 3

### IR Spectroscopy on TAPSO-34 not According to the Invention

To determine the tetrahedrally coordinated titanium atoms in the titano-silico-aluminophosphate not according to the invention, the latter was examined with IR spectroscopy. The tetrahedral coordination of the titanium can be detected after a CO adsorption at a free coordination site of the titanium on the basis of a characteristic CO—Ti vibration band at 2192±5 cm⁻¹ by means of IR spectroscopy.

For comparison, samples of SAPO-34 not containing titanium and a mixture consisting of SAPO-34 not containing titanium and 3.4 wt.-% TiO₂ (anatase) were also examined by means of IR spectroscopy after CO treatment. As TAPSO-34 not according to the invention and SAPO-34 not containing titanium have the same structure, the latter was selected as comparison substance. As further comparison substance a mixture consisting of SAPO-34 not containing titanium and TiO₂ was examined with the same method, as here the titanium atoms are not present inserted in the framework of the silico-aluminophosphate.

### Test Procedure:

The powdery samples, TAPSO-34 not according to the invention, SAPO-34 not containing titanium and SAPO-34 not containing titanium and a mixture consisting of SAPO-34 not containing titanium and 3.4 wt.-% TiO₂ were pressed into self-supporting tablets with a diameter of 13 mm and a weight of from 10 to 20 mg with a pressure of approx. 0 to 3 metric tonnes. The FTIR measurements of adsorbed carbon monoxide were recorded on a Thermo Nicolet 4700 spectrometer with MCT detector. The apparatus had a specially designed high-vacuum system with connected low-temperature cell (window material ZnSe). The IR spectra were recorded in transmission mode with a resolution of 4 cm⁻¹ at a range of from 400 to 4000 cm⁻¹ and with 128 scans. The sample was activated in high vacuum (max. 1×10⁻⁵ mbar) for 2 h at a temperature of 450° C. The cell was then cooled to −196° C. with the help of liquid nitrogen. Then, at 10 mbar, carbon monoxide was adsorbed and evacuated again gradually until no more CO bands were visible or a constant state had been established. Before every spectrum a constant quantity of helium was passed into the cell to ensure a constant sample temperature.

The IR spectra of TAPSO-34 according to the invention, TAPSO-34 not according to the invention, SAPO-34 not containing titanium and the mixture of SAPO-34 not containing titanium and TiO₂ are given in FIG. 1.

It was shown that the titano-silico-aluminophosphate not according to the invention also has no detectable CO band in the IR spectrum at 2192±5 cm⁻¹. As very little titanium is inserted in the framework there are therefore almost no tetrahedrally coordinated titanium atoms present. The IR band characteristic of tetrahedral titanium inserted in the framework should be visible at 2192±5 cm⁻¹, but is not found either in SAPO-34 or in SAPO-34 mixed with TiO₂.

1. Titano-silico-aluminophosphate with tetrahedrally coordinated titanium which has a free coordination site for CO.

2. Titano-silico-aluminophosphate according to claim 1, wherein the tetrahedrally coordinated titanium has a Ti—CO band in the IR spectrum at 2192±5 cm⁻¹.

3. Titano-silico-aluminophosphate according to claim 2, wherein the Ti—CO IR band has an intensity of from 0.005 to 0.025.

4. Titano-silico-aluminophosphate according to claim 3, wherein the titano-silico-aluminophosphate contains 0.06 to 5 wt.-% titanium in the framework.

5. Titano-silico-aluminophosphate according to claim 4, wherein the titano-silico-aluminophosphate has a Ti/Si/(Al+P) ratio of from 0.01:0.01:1 to 0.2:0.2:1.

6. Titano-silico-aluminophosphate according to claim 5, wherein the titano-silico-aluminophosphate has a Si/Al ratio of from 0.05 to 3.

7. Titano-silico-aluminophosphate according to claim 6, wherein the titano-silico-aluminophosphate has a hydrothermal stability up to 900° C.

8. Titano-silico-aluminophosphate according to claim 7, wherein it is selected from TAPSO-5, TAPSO-8, TAPSO-11, TAPSO-16, TAPSO-17, TAPSO-18, TAPSO-20, TAPSO-31, TAPSO-34, TAPSO-35, TAPSO-36, TAPSO-37, TAPSO-40, TAPSO-41, TAPSO-42, TAPSO-44, TAPSO-47, TAPSO-56.

9. Titano-silico-aluminophosphate according to claim 8, wherein the titano-silico-aluminophosphate contains at least one further metal selected from lithium, sodium, potassium, magnesium, calcium, strontium, barium, scandium, titanium, vanadium, chromium, manganese, iron, nickel, copper, zinc, gallium, germanium, cobalt, boron, rubidium, yttrium, zirconium, niobium, molybdenum, ruthenium, rhodium, palladium, silver, cadmium, indium, tin, lanthanum, hafnium, tantalum, tungsten, rhenium, osmium, iridium, platinum, gold, and/or bismuth.

10. Titano-silico-aluminophosphate according to claim 9, wherein the titano-silico-aluminophosphate containing a further metal contains metal in the range of from 1 wt.-% to 20 wt.-% relative to the total weight of the titano-silico-aluminophosphate.

11. Titano-silico-aluminophosphate according to claim 1, the crystallite size of which is between 0.1 μm and 10 μm.

12. A method for producing a titano-silico-aluminophosphate, comprising the steps of:
a) providing an aqueous synthetic gel mixture containing at least an aluminium source, a phosphorus source, a silicon source, a template and a titanium source,
b) stirring for several hours at a temperature in the range of 150 to 350° C.,
c) filtering and drying at a temperature of 100° C.,
d) calcining at a temperature in the range of 400 to 600° C., and
e) obtaining a titanium-containing silico-aluminophosphate.
